(19) United States
(12) Patent Application Publication
(10) Pub. No.: US 2024/0062163 A1
(43) Pub. Date: Feb. 22, 2024

(54) METHODS AND SYSTEMS FOR AUTOMATED EVENT SCHEDULER

(71) Applicant: Akkaravuth KOPSOMBUT, Chicago, IL (US)

(72) Inventor: Akkaravuth KOPSOMBUT, Chicago, IL (US)

(21) Appl. No.: 18/236,801

(22) Filed: Aug. 22, 2023

Related U.S. Application Data
(60) Provisional application No. 63/399,873, filed on Aug. 22, 2022.

(51) Int. Cl. G06Q 10/1093; G06F 3/0481

(52) U.S. Cl. CPC G06Q 10/1093; G06F 3/0481

(57) ABSTRACT

A method of scheduling a calendar event is disclosed. The method includes a user client system displaying on a graphical user interface an input mechanism, and in response to only a single action being performed, the user client system sending a request to schedule a calendar event to a server system. The server system receives the request and obtains a plurality of candidate calendar events that meets a plurality of user resources. The server system then generates a calendar event selected from the plurality of candidate calendar events and displays at the user client system a confirmation that the calendar event is scheduled.

### CROSS-REFERENCE TO RELATED APPLICATION

This application claims the benefit of U.S. Provisional patent Application No. 63/399,873 filed on Aug. 22, 2022, which is incorporated by reference herein in its entirety.

### TECHNICAL FIELD

The disclosed embodiments relate generally to calendar event scheduling. More particularly, the disclosed embodiments relate to methods, systems, and graphical user interfaces for scheduling calendar events.

### BACKGROUND

Electronic calendars are used to organize our lives, and have become essential to conducting both in-person meetings, and electronic conferencing meetings. Such calendars are accessed from laptop and desktop computers, as well as portable computing devices including smart phones.

One problem with calendaring is that a plurality of constraints should be met, and these constraints can differ whether the meeting is in-person or over electronic conferencing software. For example, an in-person meeting has the unique constraints of having to locate a venue that works for all meeting participants, whereas electronic software conferencing software may have to account for meeting participants in different time zone. Additionally, all meetings have to deal with the constraints of having to align schedules that work for all meeting participants, and finding open time slots that are not occupied by a conflicting planned event. Meeting even most of these constraints often involves manually examining for open time slots, discussing available options with other meeting participants, and repeating the process when a conflicting event surfaces for one of the meeting participants. Therefore, there is a need for an automated system for assisting an event creator user in scheduling and re-scheduling meetings.

### SUMMARY

In accordance with one aspect of the present disclosure, a method of scheduling a tentative calendar event is disclosed. The method includes a user client system displaying on a graphical user interface an input mechanism, and in response to only a single action being performed, the user client system sending a request to schedule a calendar event to a server system. The server system receives the request and obtains a plurality of candidate calendar events that meets a plurality of user resources. The server system then generates a tentative calendar event selected from the plurality of candidate calendar events and displays at the user client system a confirmation that the tentative calendar event is scheduled.

In accordance with another aspect of the present disclosure, a method is disclosed. The method includes receiving a request from a user client system to schedule a calendar event at a server system. In response to the request, the server system obtains a plurality of candidate calendar events that meet a plurality of user resources. The server then displays on a graphical user interface on each of other user client systems a plurality of user-editable options that corresponds to the plurality of candidate calendar events and an input mechanism. After the server system receives an input at the input mechanism in response to the user-editable options, the server system automatically generates a tentative calendar event that is selected from the plurality of candidate calendar events, and displays a confirmation that the tentative calendar event is scheduled on the user client system.

In accordance with a further aspect of the present disclosure, a non-transitory computer readable storage medium storing a program configured for execution by a computer system is disclosed. The program has instructions for obtaining a request from a user client system to schedule a calendar event at a server system. The server system then calculates a plurality of candidate calendar events that meet a plurality of user resources. Next, the server system displays at a graphical user interface at a second client system the plurality of candidate calendar events and an input mechanism. In response to a single action that is performed at the input mechanism, the server system automatically generates a tentative calendar event that is selected from the plurality of candidate calendar events and displays a confirmation on the second client system.

### BRIEF DESCRIPTION OF THE DRAWINGS

FIG. 1 is a block diagram illustrating an exemplary distributed computer system, in accordance with an exemplary embodiment of the present disclosure.

FIG. 2 is a block diagram illustrating an exemplary event schedule system, in accordance with an exemplary embodiment of the present disclosure.

FIG. 3 is a block diagram illustrating an exemplary user resource database and an exemplary request queue or request log, in accordance with an exemplary embodiment of the present disclosure.

FIG. 4 is a schematic screen shot of an exemplary graphical user interface for displaying details associated with scheduling a calendar event, in accordance with an exemplary embodiment of the present disclosure.

FIG. 5 is a schematic screen shot of an exemplary graphical user interface for displaying a set of candidate calendar events, in accordance with an exemplary embodiment of the present disclosure.

FIG. 6 is a schematic screen shot of an exemplary graphical user interface for displaying a calendar view for scheduling a calendar event, in accordance with an exemplary embodiment of the present disclosure.

FIG. 7 is a schematic screen shot of an exemplary graphical user interface for displaying a tentative calendar event, in accordance with an exemplary embodiment of the present disclosure.

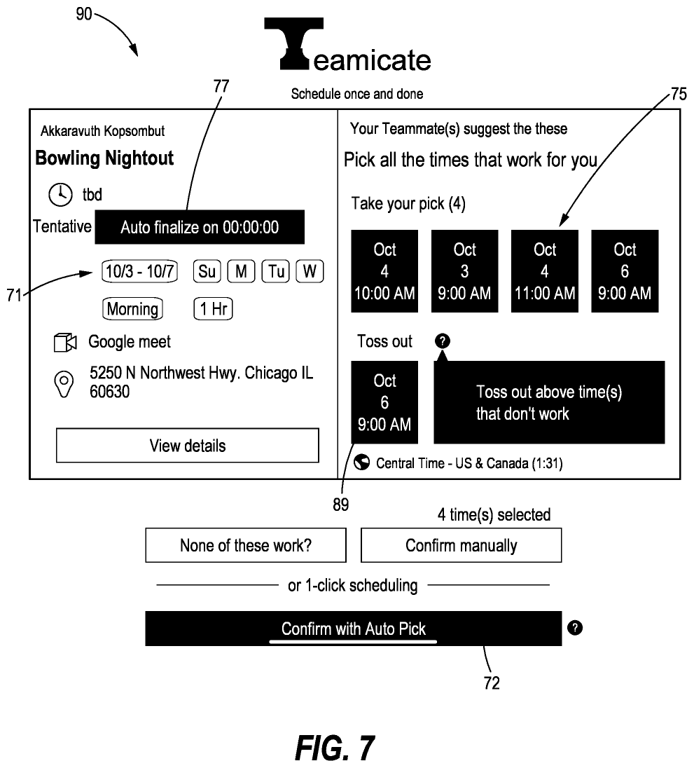

FIG. 8 is a flowchart representing a method of scheduling a calendar event, in accordance with an exemplary embodiment of the present disclosure.

FIG. 9 is a flowchart representing another method of scheduling a calendar event, in accordance with an exemplary embodiment of the present disclosure.

FIG. 10 is a flowchart representing an even further method of scheduling a calendar events, in accordance with an exemplary embodiment of the present disclosure.

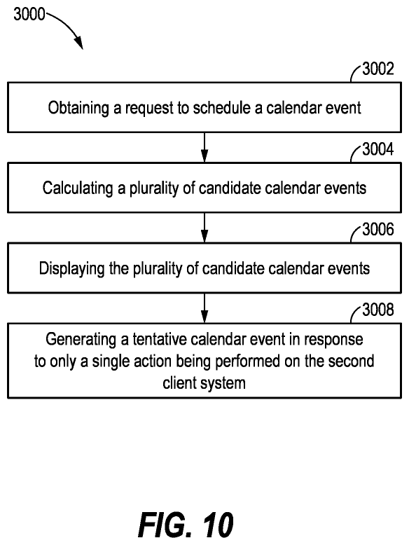

### DETAILED DESCRIPTION

Methods and systems for scheduling a calendar event in an electronic calendar are described. Reference will be made to certain disclosed embodiments, examples of which are illustrated in the accompanying drawings. While the present disclosure will be described in conjunction with the disclosed embodiments, it will be understood that it is not intended to limit the present disclosure to these particular embodiments alone. On the contrary, the present disclosure is intended to cover alternatives, modifications and equivalents that are within the spirit and scope of the disclosed embodiments as defined by the appended claims.

Moreover, in the following description, numerous specific details are set forth to provide a thorough understanding of the present disclosure. However, it will be apparent to one of ordinary skill in the art that the disclosed embodiments may be practiced without these particular details. In other instances, methods, procedures, components, and networks that are well-known to those of ordinary skill in the art are not described in detail to avoid obscuring aspects of the present disclosure.

It will also be understood that, although the terms first, second, etc. may be used herein to describe various elements, these elements should not be limited by these terms. These terms are only used to distinguish one element from another.

The terminology used in the description of the present disclosure is for the purpose of describing particular embodiments only and is not intended to be limiting of the present disclosure. As used in the description of the present disclosure and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting (the stated condition or event)” or “in response to detecting (the stated condition or event),” depending on the context.

As used herein, the term “event creator” is used to mean a person scheduling, initiating, or organizing a meeting.

As used herein, the terms “meeting” and “event” are used interchangeably to mean a calendar event involving one or more participants. As used herein, “meetings” can include both single-participant meetings (e.g., a person reserving a conference room for a video or audio conference), and multiple-participant meetings.

As used herein, the terms “attendee” and “user attendee” have been used interchangeably to mean people who have been invited to an event, irrespective of whether they have accepted, declined, or not yet responded to the invitation.

As used herein, the term “conference room amenities” is used to mean furnishings, equipment, and/or functions in conference rooms, such as one or more of: tables, chairs, desks, podium, blackboard, whiteboard, electronic whiteboard, overhead projector, slide projector, video monitor, video camera, video conferencing equipment, television, video cassette recorder (VCR), digital video disc (DVD) player, compact disc (CD) player, tape player, tape recorder, computer, network lines, phone, fax, sound system, flip charts, telecommunication equipment, window, and access to a wireless network.

As used herein, the term “user” is used to mean a account holders, or subscribers, that have accounts with the server systems used to facilitate the provided methods, systems, and apparatuses performing said methods, including any associated databases, and allow calendrical and/or scheduling data to be stored, or accessed, by the server systems. The term “non-user” hereby denotes a non-account holder, or non-subscriber, that doesn't have an account associated with the programs and/or server system used to facilitate the present methods, including any associated databases, and does not allow calendrical and/or scheduling data to be stored, or accessed, by the server systems.

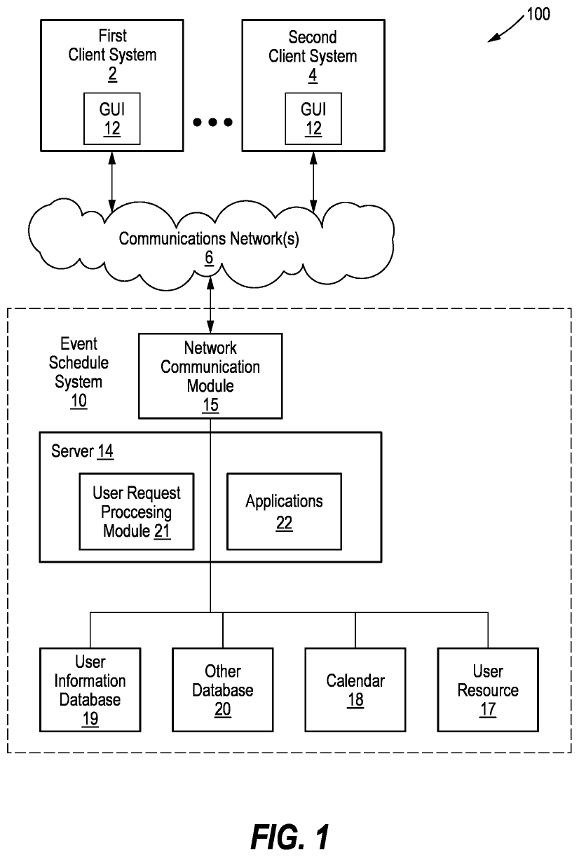

FIG. 1 is a block diagram illustrating an exemplary distributed computer system 100, according to certain embodiments of the present disclosure. System 100 may include one or more client computers, such as first client system 2 and second client system 4. The system 100 may also include a communications network 6 and an event schedule system 10.

The client systems 2, 4 can be any number of computing devices (e.g., internet kiosk, personal digital assistants, cell phones, desktop computer, tablet, laptop computer, or combination thereof) used to enable activities described below. Client computers 2, 4 also referred to herein as client(s), are described in greater detail below, and may be user client systems or non-user client system. Further, they may be user event creator client systems, or user attendee (or prospective attendee) client systems. A graphical user interface 12 is used to display a portion of a calendar and an interface of the event schedule system 10 for scheduling calendar events. The client systems 2, 4 are connected to the event schedule system 10 via communication network 10.

Event schedule system 10 includes one or more servers, such as server 14, connected to the communications network 6 via network communications module 15. Event schedule system 10, also referred to as the server system 10, includes a user resource database 17, a calendar database 18, a user information database 19, and other database 20 for storing other information, such one or more social network databases, communications databases, and/or additional databases. Further, the databases may be referred to as a memory. Server 14 includes a user request processing module 21 and applications 22. The network communications module 15 connects server 14 to the communication network 6 and enables the receipt of communications from the communication network 6 and the provision of communications to the communication network 6 bound for the respective client 2, 4 or other destinations. Server 14 communicates with databases, or memories, internal to the event schedule system 10, such user information database 19, other database 20, calendar database 18, and user resource database 17, and any other databases, if any. These internal communications may be handled by network communication module 15, by a local area network, by internal communication busses, or by any other appropriate mechanism or combination of mechanisms.

Server 14 communicates with clients 2, 4 via network communication module 15 and communication network(s) 6. In the cases where the even schedule system 10 includes multiple servers, each server, such as server 10, is coupled to a communications network 6 via a network communication module 15. The communications network 6 may be the internet but may also be any local area network (LAN), wide area network (WAN), metropolitan area network, or a combination of such networks. In some embodiments, server 10 is a Web server that manages electronic calendars using appropriate communication protocols. Alternatively, if server 10 is used within an intranet, it may be an intranet server.

The user information database 19 stores information (e.g. metadata) associated with the users of the event schedule system 10. For example, this may include account information for all users of the event schedule system 10, including user preferences, user identification information including name, address, and email, the user's base location, base time zone, and working hours.

The calendar database 18 may store information (e.g., metadata) concerning individual calendar entries such as the start date and time, duration, recurrence rules, location, and optionally, additional information such as conference room requirements and user actions. Some calendar entries will have only a subset of the aforementioned information items. The calendar database 18 may also store various types of calendars as well as data from various calendars and may be in communication with third-party calendar applications that are located on separate servers.

The user resource database 17 stores information (e.g., metadata) concerning parameters for a calendar event that are predetermined by a user on their client system 2, 4 before being sent from the client system 2, 4 to the user resource database 17. A user can store predetermined user resources 50 whether they are the user event creator or user attendee.

For example, user event resources 50 may include a preselected date range for a desired calendar event. For example, a user event creator may wish to schedule a calendar event in the next 30 days, between August 15 of the current year and November 3 of the current year, or in the business week. Any desired date range may be predetermined by the user event creator before sending invites for a calendar event. Pre-determined by the user means information that user enters to be stored on the user resource database 17. User event creator resources may also include an hour range (such as between normal business hours, or not during lunch time) for a desired calendar event, a time of day range (such as in the morning or in the evening), an event type (such as in person meeting or an electronic video conferencing meeting), a predetermined event venue (such as a conferencing room), or an event duration (such as how many hours, or how long, the meeting will be). Further, non-predetermined, or other information that is collected when the event creator user creates or edits their account with the server system 10, or information that is automatically collected by the server system 10 based on their IP address, may be stored on the user resource database. Such information may include the event creator user's work and home time zones or the event creator user's location.

The user resource database may also store information that is by the user attendee. Pre-determined, or entered, information may include the user attendee's preferred meeting time range, preferred meeting day ranges, any date or time exclusions to not schedule a calendar event, or the like. Further, non-predetermined, or other information that is collected when the attendee user creates or edits their account with the server system 10, or information that is automatically collected by the server system 10 based on their IP address, may be stored on the user resource database. Such information may include the attendee user's work and home time zones or the attendee user's location. The event creator user and the attendee user are being described separately to describe the type of information that may be predetermined, or collected, and stored on the user resource database, but a user holding an account with the server system 10 may be an event creator or attendee, depending on if they are the user creating the calendar event invitation or being invited the calendar event.

Notwithstanding the discrete blocks in FIG. 1, the figure is intended to be a functional description of some embodiments of the present disclosure rather than a structural description of functional elements in the embodiments. One of ordinary skill in the art will recognize that an actual implementation might have the functional elements grouped or split among various components. For example, user information databases 19 may be part of or stored within server system 14. In some embodiments, user information databases 19 may be implemented using one or more servers whose primary function is to store and process user information. Similarly, user resource database 17 may be implemented on one or more servers. The actual number of servers used to implement the event schedule system 10 and how features are allocated among them will vary from one implementation to another, and may depend in part on the amount of data traffic that the system must handle during peak usage periods as well as during average usage periods, and the amount of data stored by even schedule system. Moreover, one or more of the blocks in FIG. 1 may be implemented on one or more servers designed to provide the described functionality. Although the description herein refers to certain features implemented in client 2, 4 and certain features implemented in server 14, the embodiments of the present disclosure are not limited to such distinctions. For example, features described herein as being part of server 14 can be implemented in whole or in part in client 2, 4, and vice versa.

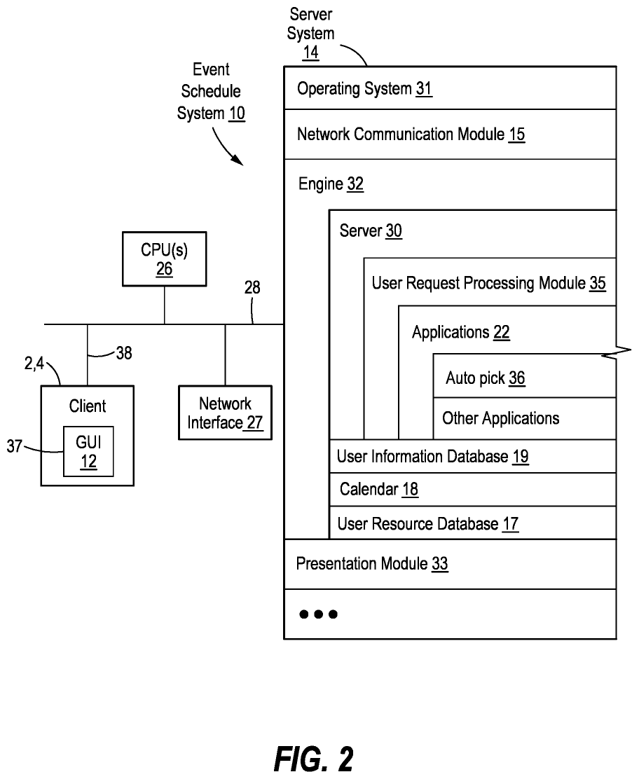

FIG. 2 is a block diagram illustrating event schedule system 10 in accordance some embodiments of the present disclosure. The event schedule system 10 includes one or more processing units (CPUs) 26, one or more network or other communications interfaces 27, memories (such as database 17-20), and one or more communication buses 28 for interconnecting these components. The communication buses 28 may include circuitry (sometimes called a chipset) that interconnects and controls communications between system components. The event schedule system 10 optionally includes a user interface (not shown) (e.g., a user interface having a display device, a keyboard, and a mouse or other pointing device), but more typically the event schedule system 10 is controlled from and accessed by various client systems.

Server system 14 of event schedule system 10 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Server system 14 may optionally include one or more storage devices remotely located from the CPU(s) 26. Server system 14, or alternately the non-volatile memory device(s) within server system 14, comprises a computer readable storage medium. In some embodiments, server system 14 or the computer readable storage medium of server system 14 stores the following programs, modules and data structures, or a subset thereof:
Operating System 31 that includes procedures for handling various basic system services and for performing hardware dependent tasks;
Network Communication Module (or instructions) 15 that is used for connecting the event schedule system to other computers (e.g., clients 2, 4) via the one or more communications Network Interfaces 27 (wired or wireless) and one or more communications networks 6 (FIG. 1), such as the internet, other wide area networks, local area networks, metropolitan area networks, and so on;
Engine 32 that receives calendar-related requests from and provides responses to clients 2, 4; and
Presentation (or display) module 33 that formats the results from the engine 32, for display.

A server 30 for managing certain aspects of event schedule system including a user request processing module 35, and applications 22. Applications 22 include an auto pick 36 application for generating a calendar event based off of a single action by the user. The information used by auto pick application to generate the calendar event is obtained from user information database 19, calendar database 18, and/or user resource database 17. Optionally, the information used by auto pick application 36 also includes information obtained from one or more of the other databases 20. For example, a conference room database includes conference room records including, for a respective conference, information regarding the location and size or capacity of the conference room, and optionally including additional information such as the amenities of the conference room, and scheduling information for the conference room. Alternately, scheduling information for the conference room may be obtained from calendar database 120.

Each of the above identified modules and applications correspond to a set of instructions for performing one or more functions described above. These modules (i.e., sets of instructions) need not be implemented as separate software programs, procedures or modules, and thus various subsets of these modules may be combined or otherwise re-arranged in various embodiments. In some embodiments, the server system 14 or the computer readable storage medium of server system 14 may store a subset of the modules and data structures identified above. Furthermore, server system 14 or the computer readable storage medium of server system 14 may store additional modules and data structures not described above.

Although FIG. 2 shows event schedule system as a number of discrete items, FIG. 2 is intended more as a functional description of the various features which may be present in server system 14 rather than as a structural schematic of the embodiments described herein. In practice, and as recognized by those of ordinary skill in the art, items shown separately could be combined and some items could be separated. For example, some items shown separately in FIG. 2 could be implemented on single servers and single items which could be implemented by one or more servers. The actual number of servers in event schedule system 14 and how features are allocated among them will vary from one implementation to another, and may depend in part on the amount of data traffic that the system must handle during peak usage periods as well as during average usage periods.

The client 2, 4 shown in this figure is configured for use by an account holder (also herein called “the user”) of the server system 14. The client includes a graphical user interface 12, which typically includes a display device 37, and one or more input devices such as a keyboard and a mouse or other pointing device (e.g., a stylus or user's finger on a touch-sensitive surface or touch-sensitive display). As noted above, client 2, 4 includes a graphical user interface (GUI) 12, which is displayed on the display device 37. Client 2, 4 typically includes one or more processing units (CPUs), one or more network or other network communications interfaces, memory, and one or more communication buses 38 for interconnecting these components. The communication buses 38 may include circuitry (sometimes called a chipset) that interconnects and controls communications between system components.

Memory includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory may optionally include one or more storage devices remotely located from the CPU(s). Memory, or alternately the non-volatile memory device(s) within memory, comprises a computer readable storage medium. In some embodiments, memory or the computer readable storage medium of memory stores the following programs, modules and data structures, or a subset thereof:
Operating System 31 that includes procedures for handling various basic system services and for performing hardware dependent tasks;
Network Communication Module 15 (or instructions) that is used for connecting client 2, 4 to other computers (e.g., the event schedule system 10, other clients) via the one or more communications Network Interfaces (wired or wireless) and one or more communication networks 6 (FIG. 1), such as the internet, other wide area networks, local area networks, metropolitan area networks, and so on;
Browser Application; optionally, the browser application or an extension, plug-in or toolbar of the browser application includes a client assistant that handles data formatting and/or management tasks, at least some of which would otherwise be handled by presentation module 33 (FIG. 2); and
Scheduling Webpage or application 22, which is a webpage or app display received from the event schedule system 10, for receiving scheduling-related input from a computer user (e.g., a request to schedule an event or to retrieve schedule data) and for presenting schedule search data in GUI 12; webpage optionally includes an embedded Scheduling Module, for receiving scheduling-related input from a computer user and for formatting schedule data for display in GUI 12.

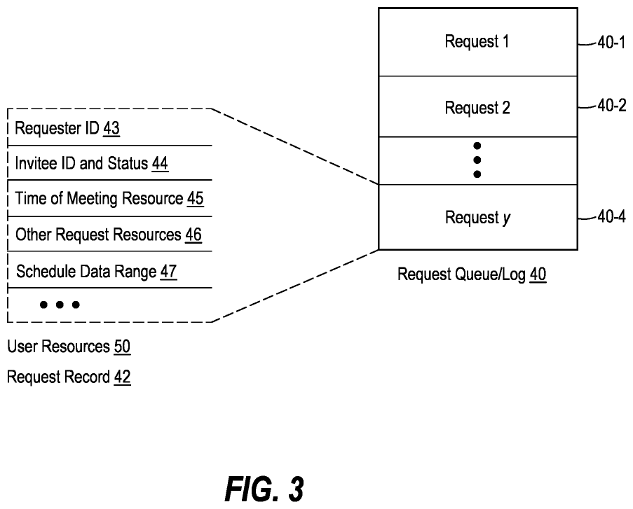

FIG. 3 is a block diagram illustrating an exemplary request queue 40 or request log (depending on the status of the request) and an exemplary request record 42, in accordance with some embodiments. The request queue/log 40 stores request records, for example request record 40-1 through request queue record 40-y, where y may represent the number of scheduling requests. In some embodiments, the request queue/log 40 is a part of the calendar schedule system 10. In other embodiments, the request queue/log 40 is maintained in a separate database (such as one of the “other databases 20”, or user resource database 17 of FIG. 1).

In some embodiments, a request record (e.g., Request Record 40-y) for a respective conference room scheduling request includes the following user resource data, or a subset or superset thereof:
Requester ID 43 that uniquely identifies a particular user event creator who initiated the calendar event request;
Invitee ID and optional status information 44 identify the invitee(s) associated with a calendar event that corresponds to the calendar request and this entry 40-y. The invitee IDs may comprise user IDs, email addresses or the like. In some embodiments, the status information, if provided, indicates which invitee(s) have accepted or declined the invitation;
Time of meeting constraints 45 (if any), such as start date, start time, end date, end time, and the duration of the meeting;
Request constraints 46 (if any) may include one or more of: whether changing the location of an already scheduled meeting is allowed, requested amenities for the conference room, requested room capacity, requested location, and requested proximity to the requester, an invitee, or another meeting; and
An optional schedule range 47 which specifies one or more dates, or days or week, time periods in which the meeting should be scheduled.

In some other embodiments, request queue records include pointers to other databases (e.g., user information database 19, or user resource database 17) which store information associated with at least a subset of the plurality of user resources 50 and include associated user preferences which may be used in addition to the specified user resources 50 in obtaining a set of candidate calendar events.

In some embodiments, the invitee ID and status 44 includes a value corresponding to the requirement level of each invitee (e.g., required attendee, optional attendee, guest/participant, user attendee or non-user attendee).

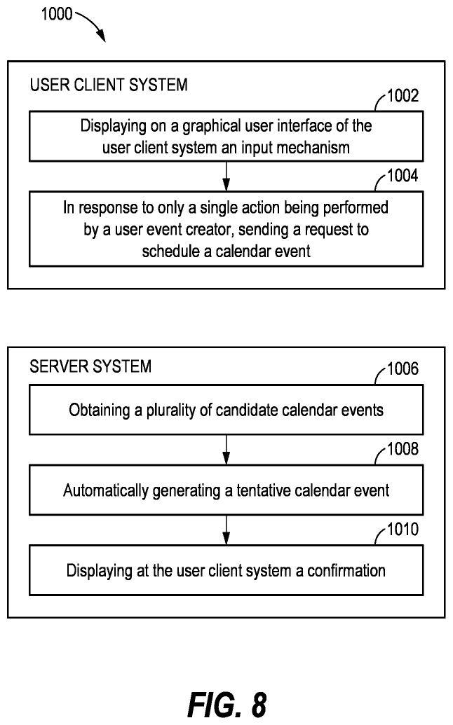

FIG. 8 is flow chart representing a method 1000 of scheduling a calendar event, in accordance with some embodiments. The method is performed on the distributed computer system 100 having one or more processors and memory storying one or more programs for execution by the one or more processors discussed with respect to FIGS. 1-2.

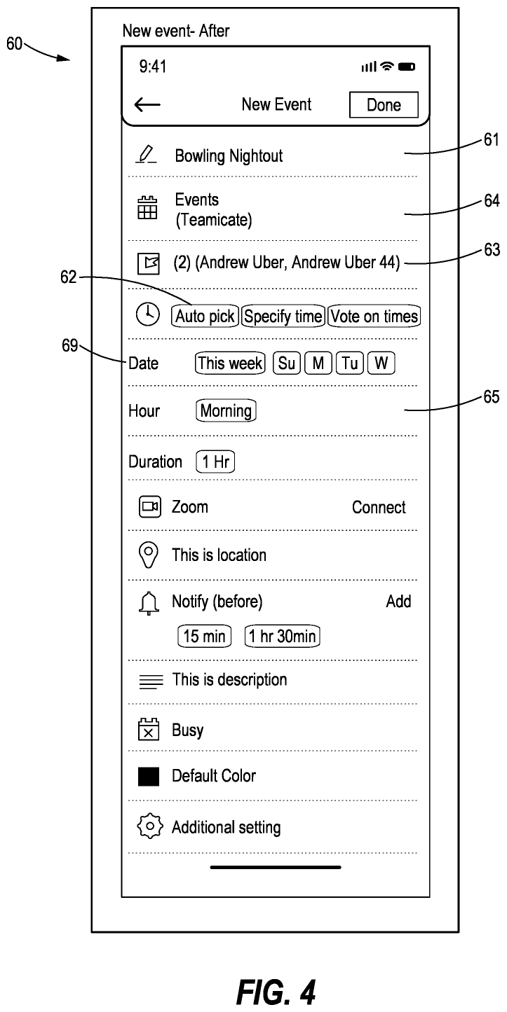

Under control of the first client system 2, also known as the user client system, at block 1002 the first client system 2 displays on the graphical user interface 12 to the user event creator an input mechanism. The input mechanism may be any known form of user interface that allows the user event creator to interact with user client system on an electronic device (cell phone, computer, etc.) through graphical icons, audio indicators, typed command labels, or text navigation. The event mechanism 62 (Auto Pick button), in some embodiments, is displayed to the user event creator in response to the user wanting to create a calendar event, and to invite an attendee user(s) to the calendar event. For example, as shown in FIG. 4, prior to displaying the input mechanism 62, the GUI 12 of the first client system 2 may also, or instead of, display to the user event creator an event parameter interface 60 in response to the user event creator wanting to schedule a calendar event. The event parameter interface may include event parameters including the title of the calendar event 61, a calendar or subject matter to be scheduled on 64, a list of user attendees to invite 63, a scheduled time input 65, date input, or auto pick input mechanism 62 (auto pick button on graphical user interface).

At block 1004, in response to only a single action being perform on the input mechanism 62, the user client system 2 sends a request to schedule a calendar event to the server system 14. The single action may be a touch input or keyboard input, for example, or any known inputs for interacting, and commanding, a computer system.

The server system, at block 1006, receives the request, and obtains a plurality of candidate calendar events that meets a plurality of user resources. The server system 14 includes a memory or hard drive that stores the user resources. The user resources, may include parameters saved to the server system by the user event creator prior to scheduling the calendar event. The user resources may include a date range available to schedule the calendar event, an hour range to schedule the calendar event, a general time of day in lieu of a hour range (such as morning, evening, or night, for example), an event space to schedule the calendar event at, an event type such as in-person, conference call, or telephonic, and event duration. The user resources are retrieved from the memory by the server system 14 and are used to calculate the plurality of candidate calendar events.

In one exemplary embodiment, after obtaining the plurality of candidate calendar events, the server system 14 assigns a point value to each of the candidate calendar events based on how closely they meet the plurality of user resources and/or attendee resources, and the server system 14 ranks the plurality of candidate calendar events based on their point value. In this embodiment, a top ranked calendar event of the plurality of candidate calendar events becomes the default calendar event.

In one exemplary embodiment, the memory further stores an attendee resource(s) associated with the user attendee(s), and the server system 14 also retrieves the attendee resource(s) prior to calculating the plurality of candidate calendar events. The attendee resource may include a time zone offset range that corresponds to a time zone where the user event creator is located. The attendee resource(s) may also include a date range available to schedule the calendar event, an hour range to schedule the calendar event, a general time of day in lieu of a hour range (such as morning, evening, or night, for example), an event space to schedule the calendar event at, an event type such as in-person, conference call, or telephonic, and an event duration.

The time zone offset range is calculated based on where the user attendee(s) is located (such as which time zone), and is compared to which time zone the user event creator is located in when calculating calendar event times. The time zone offset range ensures that no proposed times in the plurality of candidate calendar events would be at a time that is not acceptable to the user event creator or the user attendee(s), such as, for example, at midnight. Both the user event creator and the user event attendee may set parameters in their respective user resource or attendee resource settings for times (or time ranges, or events such as holidays or weekends) that they would not want a calendar event to take place.

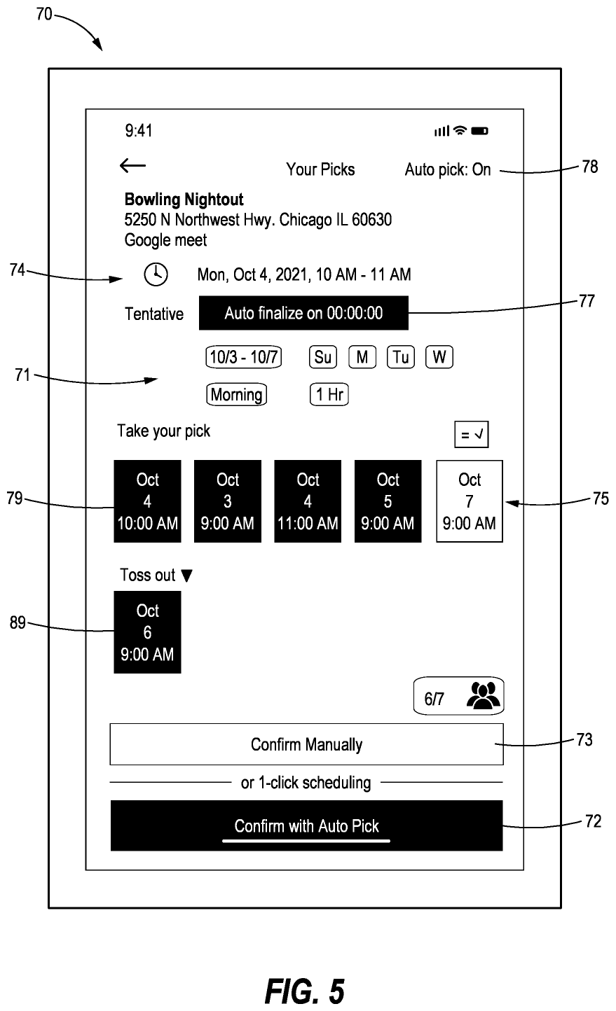

At block 1008, the server system 14 automatically generates a calendar event selected from the plurality of candidate calendar events, and at block 1010 displays at the user client system a confirmation that the calendar event is scheduled. As best shown in FIG. 5, the user interface 70 displayed on either the first or second client systems 2, 4 after the steps of blocks 1008 and 1010, and more specifically, the generated plurality of candidate calendar events 79, the default selected candidate calendar event 75, and confirmation button 72 are displayed on the user event creator client system 2 and/or the attendee user client system 4.

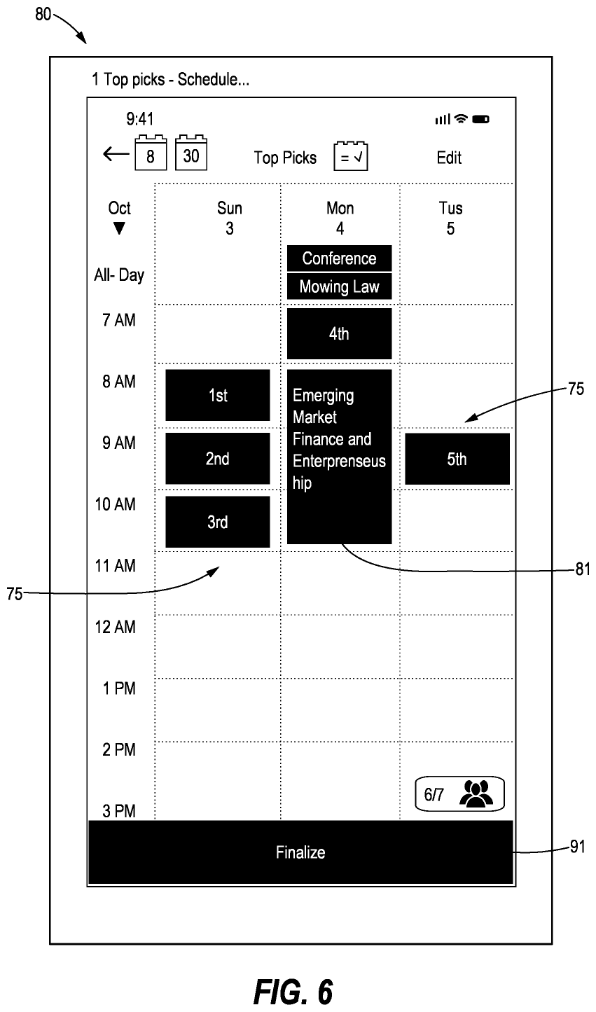

The plurality of user candidate calendar events 79, as shown in FIG. 5, may include the calculated (by the server system 14) plurality of candidate calendar events. Each candidate calendar event includes a date and/or a time, and was calculated based on the user resources and/or the attendee resources. In one exemplary embodiment, as conflicting calendar event 75 (FIG. 6) (conflicting with the date/time of the plurality of candidate calendar events 79) are added to either the user event creators calendar, or the attendee user's calendar, the server system 14 calculates and displays (on client systems 2, 4) a new replacement candidate calendar event to replace the candidate calendar event. Further, the server system may be in operative communication with a third party calendar system on a separate server to receive the conflicting calendar event information.

The server system 14 determines the default selected candidate calendar event 75 based on the calculated candidate calendar event that best meets the user resources and/or the attendee resources, meaning it has the least amount (or none) conflicts with said resources. If a user decides that they do not desire to have the calendar event at one of the candidate calendar events, they may swipe to toss out (delete) one of the candidate calendar events. This of course can be done through a number of ways, and including selecting to delete one of the candidate calendar events through a touch or computer input. If one of the candidate calendar events is tossed out, the server system 14 calculates a replacement candidate calendar event to replace the tossed out candidate calendar event, and updates the plurality of candidate calendar events to be displayed on the client systems 2, 4.

Also shown in FIG. 5 is the confirm with Auto Pick button 72. If the user event creator, or the user attendee, selects this input on their respective client systems 2, 4, then the user is allowing the server system to finalize the calendar event scheduling with the default selected candidate calendar event. This means that once the Auto Finalize timer 77 (FIG. 5), in one exemplary embodiment, reaches 0, the server system automatically schedules the calendar event for the user event creator and the user attendee(s) for the default selected candidate calendar event 75. Further, if any of the other user attendee(s) manually selected one of the candidate calendar events, or the calendar event that has the most selections (or votes) from all the user attendee(s), then the candidate calendar event with the most selections is scheduled when the auto finalize timer 77 reaches zero. Thus, a user event creator, after pressing the input mechanism 62 (auto pick button) when creating the calendar event invite, is not required to make any further inputs to schedule the calendar event. The Auto Finalize timer 77 will allow the user event creator, or any of the user attendees to continuously toss out candidate calendar events, select candidate calendar events (or votes), or add events to their calendars prior to the expiration of the Auto Finalize timer 77, and the server system 14 continuously calculating new candidate calendar events as replacements. Once the Auto Finalize timer 77 runs out and a calendar event is scheduled, the server system 14 displays on the first or second client systems 2, 4 a confirmation that a calendar event has been scheduled.

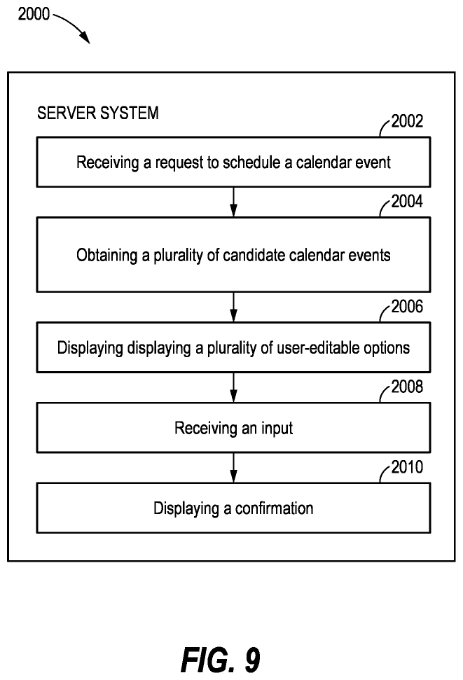

FIG. 9 is a flow chart demonstrating another method of scheduling a calendar event. In this method, after calculating and displaying the plurality of candidate calendar events in block 2004, the server system 14 displays on the first or second client systems 2, 4 a plurality of user-editable options corresponding to the plurality of candidate calendar events. The user-editable options may correspond to the options shown in FIG. 5, such as the time/date 74, or the time ranges and date ranges 71. In this embodiment, the user event creator or user attendee may manually make desired selections of date/time, rather specific or ranges, to schedule the calendar event. The user-editable options may further include tossing out 89 (deleting) a candidate calendar event, or voting on a candidate calendar event, as outlined above. If a manual user-editable option is selected, the server system 14 automatically calculating a new candidate calendar event to replace any candidate calendar events that were tossed out or in conflict with the manually selected changes. If a user-attendee makes a manual date/time selection, the manually selected date time is used to calculate a new candidate calendar event if none of the existing candidate calendar events are within the manually selected date/time. Further, this candidate calendar event (meeting manually selected date/time) becomes the default selected candidate calendar event.

As shown in FIG. 6, once a calendar event is confirmed at the expiration of the Auto finalize timer 77, the scheduled calendar event 81 is displayed on the user event creators calendar 80 as a confirmation. In another exemplary embodiment, the confirmation is a notification of the event creators GUI 12.

What is claimed is:

1. A method of scheduling a calendar event, comprising:
under control of a user client system,
displaying on a graphical user interface of the user client system an input mechanism; and
in response to only a single action being performed on the input mechanism, sending a request to schedule a calendar event to a server system;
under control of a server system,
receiving the request;
obtaining a plurality of candidate calendar events that meets a plurality of user resources;
automatically generating a calendar event selected from the plurality of candidate calendar events;
displaying at the user client system a confirmation that the calendar event is scheduled.

2. The method of claim 1, in which the server system includes and is in operative communication with a memory, the memory storing the user resources, and the user resources are retrieved from the memory by server system before obtaining the plurality of candidate calendar events.

3. The method of claim 2, in which the user resources includes at least one of a date range, a hour range, a time of day, an event space, an event type, or an event duration.

4. The method of claim 3, in which the memory storing an attendee resource, the server system retrieving the attendee resource from a second user client system prior to obtaining the plurality of candidate calendar events, and the plurality of candidate calendar events also meets at least one attendee resource.

5. The method of claim 4, in which after obtaining the plurality of candidate calendar events, the server displaying the plurality of candidate calendar events at the second user client system, and the server automatically generating the calendar event after a predetermined period of time.

6. The method of claim 4, in which the attendee resource includes a time zone offset range that corresponds to a time zone where the user event creator is located.

7. The method of claim 4, in which after automatically generating the calendar event, the server interacting with a calendar system on the user client system to generate a calendar event.

8. The method of claim 7, further comprising displaying on a calendar interface of the calendar system an event display that corresponds to the calendar event.

9. The method of claim 7, in which if any of the plurality of candidate calendar events becomes unavailable due to a conflicting calendar event that is added to the calendar system on the user client system or a second user calendar system on the second user client system after the plurality of candidate calendar events was obtained, the server obtaining a replacement candidate calendar event and discarding the conflicting calendar event from the plurality of candidate calendar events.

10. The method of claim 9, in which the server displaying the updated plurality of candidate calendar events on the first or second user client systems.

11. The method of claim 9, in which the server automatically generating a new calendar event selected from the updated plurality of candidate calendar events

12. A method comprising:
at a server system receiving a request from a user client system of two or more user client systems to schedule a calendar event; and
in response to obtaining the request to schedule the calendar event:
obtaining a plurality of candidate calendar events that meet a plurality of user resources;
displaying on a graphical user interface at each of the two or more user client systems a plurality of user-editable options corresponding to the plurality of candidate calendar events and an input mechanism;
after receiving at least one input at the input mechanism, automatically generating a calendar event selected from the plurality of candidate calendar events; and
displaying at the user client system a confirmation that a calendar event is scheduled.

13. The method of claim 12, in which the plurality of candidate calendar events also meets an attendee resource associated with a user attendee identified in the request.

14. The method of claim 13, in which after obtaining the plurality of candidate calendar events assigning a point value to each of the candidate calendar events based on how closely they meet the plurality of user resources and the attendee resource, and ranking the plurality of candidate events based on their point value, in which a top ranked calendar event of the plurality of candidate calendar events becomes the calendar event.

15. The method of claim 13, in which the user-editable options includes the user attendee removing one or more candidate calendar events from the plurality of the candidate events.

16. The method of claim 15, in which when one or more of the candidate calendar events are removed, the server obtaining a replacement candidate calendar event and discarding the conflicting calendar event from the plurality of candidate calendar events.

17. The method of claim 16, in which the server displaying at the two or more user client systems the updated plurality of calendar events

19. A non-transitory computer readable storage medium storing one or more programs configured for execution by a computer system, the one or more programs comprising instructions for:
at a server system obtaining a request from a user client system to schedule a calendar event;
in response to obtaining the request to schedule the calendar event, the server system calculating a plurality of candidate calendar events that meet a plurality of user resources;
the server system presenting for display on a graphical user interface at a second client system the plurality of candidate calendar events and an input mechanism; and
in response to only a single action being performed on the second client system at the input mechanism, the server system automatically generating a calendar event selected from the plurality of candidate calendar events and displaying a confirmation on the second client system a calendar event is scheduled.

20. The non-transitory computer readable storage medium of claim 19, in which the second client system is a non-user client system, and the server system receiving a request to from the client system to become a user client system prior to the server presenting for display the plurality of candidate calendar events.
